(19) United States
(12) Patent Application Publication
(10) Pub. No.: US 2017/0221242 A1
(43) Pub. Date: Aug. 3, 2017

(54) AUTOMATIC OVERDRAW REDUCTION BEFORE RENDERING

(71) Applicant: Facebook, Inc., Menlo Park, CA (US)

(72) Inventor: Andrew Lankes Street, Midlothian, VA (US)

(21) Appl. No.: 15/012,666

(22) Filed: Feb. 1, 2016

(51) Int. Cl. G06T 11/60; G06T 5/50

(52) U.S. Cl. CPC G06T 11/60; G06T 5/50; G06T 2207/20224; G06F 3/0481

(57) ABSTRACT

Disclosed are ways to render pages more quickly and using fewer computational and memory resources by automatically avoiding rendering elements or portions of elements that are fully or partially occluded. Various embodiments automatically reduce the rendering of overdrawn portions of views while achieving the originally specified user interface. Some embodiments remove a displayed color or image property of a view that is fully occluded. Some embodiments substitute a smaller portion of a view that is partly occluded in place of the original element. Modifying overdrawn elements as disclosed can decrease rendering load and improves computing device display responsiveness.

### BACKGROUND

Computing devices display information via user interfaces. User interfaces often include a layered collection of elements or “views” to be drawn to a screen. It is common for user interface systems to render views composed of overlapping rectangles or boxes that contain and/or arrange content such as images or text. Each view may have properties, such as a background color or image. Such views or elements may be organized in a hierarchical logical data structure in memory, such as in a tree. For example, web browsers conventionally use a Document Object Model (“DOM”) to organize and represent objects in web pages (e.g., HTML, XHTML, and XML documents), and native display systems such as iOS® and Android™ can use similar hierarchical models to represent views for display on various computing device user interfaces. A rendering engine executes commands to draw the rectangles or boxes (or, other polygons, e.g., triangles) with specified coordinates to the screen according to the specified views.

### BRIEF DESCRIPTION OF THE DRAWINGS

FIG. 1 is a block diagram showing some of the components typically incorporated in computer systems and other devices on which a system that automatically reduces overdraw can be implemented.

FIG. 2 is a system diagram illustrating an example of a computing environment in which an automatic overdraw reduction system can be utilized.

FIG. 3 is a data flow diagram illustrating logical relationships among automatic overdraw reduction components in accordance with an embodiment.

FIGS. 4A and 4B are display diagrams illustrating automatic overdraw reduction in accordance with an embodiment.

FIGS. 5A and 5B are display diagrams illustrating automatic overdraw reduction in accordance with an embodiment.

FIG. 6 is a flow diagram illustrating a process for a computer system to automatically reduce overdraw in accordance with an embodiment.

### DETAILED DESCRIPTION

### Overview

The amount of time available to render a frame containing a full screen of views or elements in a user interface can be limited, especially in the context of redrawing the screen (e.g., in response to user input such as scrolling). The amount of time spent rendering each frame is typically proportional to the number of rendering commands sent to a display component, e.g., a rendering engine, graphics processor, etc. Rendering commands are instructions to render (e.g., draw) a particular view. If too many commands are sent, the display system may not be able to keep up; the result can be dropped frames that can cause a visual stuttering effect or choppiness instead of smooth, responsive movement, e.g., when a user scrolls the resulting display. The disclosure is directed to reducing the number of rendering commands to be sent to render a layered collection of elements to be drawn to a screen, such as a mobile device screen. It is common for one element or a series of elements in the foreground to overdraw and thus occlude an element in the background. As a result, some elements are not visible, even if they are drawn to the screen. The inventors of the present disclosure have determined that properties of occluded elements or views that would cause the device to draw a background image or color not visible to an end user can be changed (e.g., un-set or resized) or removed, thereby reducing the number of rendering commands to be sent and thus improving rendering performance.

The present disclosure describes automatic overdraw reduction before rendering, including systems and methods for rendering pages more quickly and with less overhead by automatically avoiding rendering an element on a page that is fully or partially occluded. Some implementations detect when an element is fully occluded (e.g., a background image or color that is covered by one or a series of foreground items) and remove the element or a property of the element so that it is not rendered. In some implementations, if an element would not be rendered on a screen, a property of the element (e.g., a background) is modified such as by un-setting the property. In some implementations, if the element is partly occluded as a result of rendering other elements (e.g., child elements) so that smaller rectangular section of the element would render, the visible rectangle is substituted for the original element or the size and/or position (e.g., coordinates and/or dimensions) of the partly occluded element are reduced to the smaller rectangular section.

Some embodiments can include a system for maintaining both an unoptimized original hierarchy of views and an optimized hierarchy of views. For example, the applicant of the present disclosure has developed a “React” JavaScript® library for building user interfaces. The React system enables a user (“developer” or “programmer”) to compose reusable user interface components and subcomponents to render views. When a page or a part of a page needs to be rendered (e.g., when it is initially displayed or updated), React returns a tree of components that will eventually be rendered (for example, to HTML elements like <div> or <span>, or to native display elements like Image or Text elements, or, e.g., MKMapView in iOS® or ImageView in Android™). React creates a data structure mirroring the original hierarchy of views, computes any differences resulting from a change to the displayed views, and then updates the displayed hierarchy efficiently. This enables a programmer to write program code as if the entire page is rendered on each change, thereby simplifying programming because the program code does not need to track which components are not visible, while the React libraries only render subcomponents that actually change. React computes the minimal set of changes necessary to keep the displayed hierarchy of views up-to-date. Although many embodiments are described herein in the context of React, embodiments are not limited to React or to rendering only updated views as determined by React libraries. Various embodiments enable optimization of views rendered for display in various computing environments, such as an application in an Android™ device. Embodiments operating in some or all of the ways described herein can reduce the number of rendering commands related to overdrawn areas, resulting in reduced rendering load, faster display rendering, and lower memory usage.

### Description of Figures

The following description provides certain specific details of the illustrated examples. One skilled in the relevant art will understand, however, that embodiments can be practiced without many of these details. Likewise, one skilled in the relevant art will also understand that the present disclosure can include many other obvious features not described in detail herein. Additionally, some well-known structures or functions may not be shown or described in detail below, to avoid unnecessarily obscuring the relevant descriptions of the various examples.

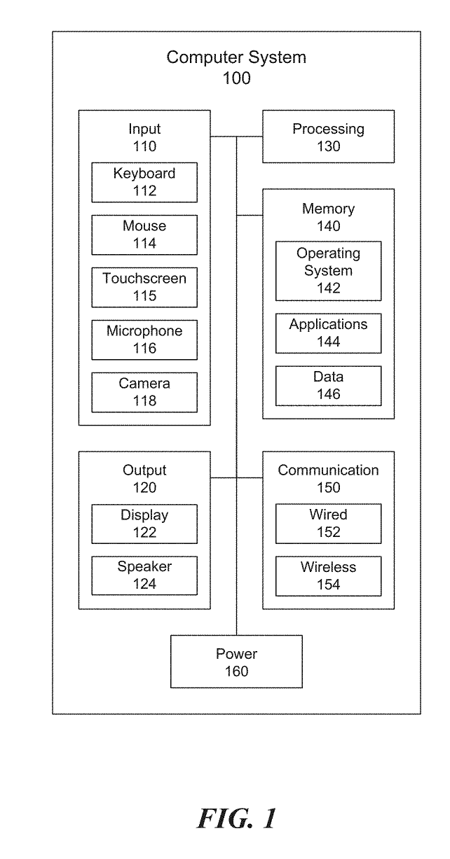

FIG. 1 is a block diagram showing some of the components typically incorporated in computing systems and other devices on which a system that provides automatic overdraw reduction can be implemented. In the illustrated embodiment, the computer system 100 includes a processing component 130 that controls operation of the computer system 100 in accordance with computer-readable instructions stored in memory 140. The processing component 130 may be any logic processing unit, such as one or more central processing units (CPUs), graphics processing units (GPUs), digital signal processors (DSPs), field-programmable gate arrays (FPGAs), application-specific integrated circuits (ASICs), etc. The processing component 130 may be a single processing unit or multiple processing units in an electronic device or distributed across multiple devices. Aspects of the system can be embodied in a special purpose computing device or data processor that is specifically programmed, configured, or constructed to perform one or more of the computer-executable instructions explained in detail herein. Aspects can also be practiced in distributed computing environments in which functions are performed by local and/or remote processing devices that are linked through a communications network, such as a local area network (LAN), wide area network (WAN), or the Internet.

The processing component 130 is connected to memory 140, which can include a combination of temporary and/or permanent storage, and both read-only memory (ROM) and writable memory (e.g., random access memory or RAM, CPU registers, and on-chip cache memories), writable non-volatile memory such as flash memory or other solid-state memory, hard drives, removable media, magnetically or optically readable discs and/or tapes, nanotechnology memory, synthetic biological memory, and so forth. A memory is not a propagating signal divorced from underlying hardware; thus, a memory and a computer-readable storage medium do not refer to a transitory propagating signal per se. The memory 140 includes data storage that contains programs, software, and information, such as an operating system 142, application programs 144, and data 146. Computer system 100 operating systems 142 can include, for example, Windows®, Linux®, Android™, iOS®, and/or an embedded real-time operating system. The application programs 144 and data 146 can include software and databases—including data structures, database records, other data tables, etc.—configured to control computer system 100 components, process information (to, e.g., reduce overdraw in graphical view data), communicate and exchange data and information with remote computers and other devices, etc. In a distributed computing environment, program modules and data can be located in both local and remote memory storage devices.

In some embodiments, the memory 140 includes program memory that contains programs and software, and data memory that includes configuration data, settings, preferences, files, documents, etc. that may be accessed by instructions from the program memory or by a component of the computing system 100. Program memory can include modules of the operating system 142 and application programs 144, such as a view management system and view rendering software for displaying and modifying views according to the present disclosure, and communication software for transmitting and receiving data by various channels and protocols via the communication components 150.

The computer system 100 can include input components 110 that receive input from user interactions and provide input to the processor 130, typically mediated by a hardware controller that interprets the raw signals received from the input device and communicates the information to the processor 130 using a known communication protocol. Examples of an input component 110 include a keyboard 112 (with physical or virtual keys), a pointing device (such as a mouse 114, joystick, dial, or eye tracking device), a touchscreen 115 that detects contact events (e.g., when it is touched by a user), a microphone 116 that receives audio input (e.g., for systems implementing speech recognition as a method of input by the user), and a camera 118 for photograph and/or video capture. The computer system 100 can also include various other input components 110 such as GPS or other location determination sensors, motion sensors, wearable input devices with accelerometers (e.g. wearable glove-type or head-mounted input devices), biometric sensors (e.g., a fingerprint sensor), light sensors (e.g., an infrared sensor), card readers (e.g., a magnetic stripe reader or a memory card reader), and so on.

The processor 130 can also be connected to one or more various output components 120, e.g., directly or via a hardware controller. The output devices can include a display 122 on which text and graphics are displayed. The display 122 can be, for example, an LCD, LED, or OLED display screen (such as a desktop computer screen, handheld device screen, or television screen), an e-ink display, a projected display (such as a heads-up display device), and/or a display integrated with a touchscreen 115 that serves as an input device as well as an output device that provides graphical and textual visual feedback to the user. The output devices can also include a speaker 124 for playing audio signals, haptic feedback devices for tactile output such as vibration, etc. In some implementations, the speaker 124 and the microphone 116 are implemented by a combined audio input-output device.

In the illustrated embodiment, the computer system 100 further includes one or more communication components 150. The communication components can include, for example, a wired network connection 152 (e.g., one or more of an Ethernet port, cable modem, FireWire cable, Lightning connector, universal serial bus (USB) port, etc.) and/or a wireless transceiver 154 (e.g., one or more of a Wi-Fi transceiver; Bluetooth transceiver; near-field communication (NFC) device; wireless modem or cellular radio utilizing GSM, CDMA, 3G and/or 4G technologies; etc.). The communication components 150 are suitable for communication between the computer system 100 and other local and/or remote computing devices, directly via a wired or wireless peer-to-peer connection and/or indirectly via a communication link and networking hardware, such as switches, routers, repeaters, electrical cables and optical fibers, light emitters and receivers, radio transmitters and receivers, and the like (which can include the Internet, a public or private intranet, a local or extended Wi-Fi network, cell towers, the plain old telephone system (POTS), etc.). The computer system 100 further includes power 260, which can include battery power and/or facility power for operation of the various electrical components associated with the computer system 100.

FIG. 1 and the discussion herein provide a brief, general description of a suitable computing environment in which a system providing automatic overdraw reduction can be implemented. Although not required, aspects of the system are described in the general context of computer-executable instructions, such as routines executed by a general-purpose computer, e.g., a mobile device, a server computer, or a personal computer. Those skilled in the relevant art will appreciate that the system can be practiced using various communications, data processing, or computer system configurations, e.g., hand-held devices (including tablet computers, personal digital assistants (PDAs), and mobile phones), laptop computers, wearable computers, vehicle-based computers, multi-processor systems, microprocessor-based consumer electronics, set-top boxes, network appliances, mini-computers, mainframe computers, virtual computing platforms, distributed computing environments that include any of the above systems or devices, etc. The terms “computer” and “electronic device” are generally used interchangeably herein, and refer to any such data processing devices and systems. While computer systems configured as described above are typically used to support the operation of a system implementing automatic overdraw reduction, one of ordinary skill in the art will appreciate that embodiments may be implemented using devices of various types and configurations, and having various components.

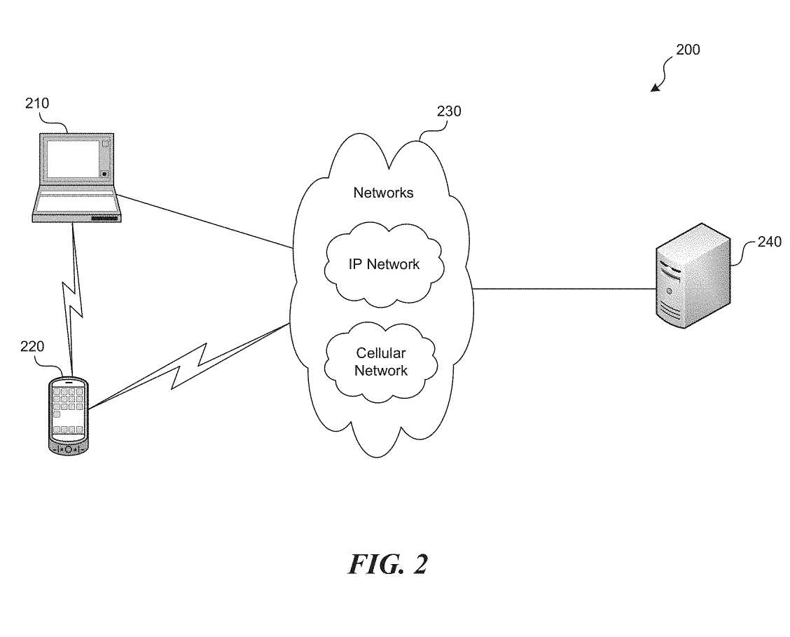

FIG. 2 is a system diagram illustrating an example of a computing environment 200 in which an automatic overdraw reduction system can be utilized. As illustrated in FIG. 2, an automatic overdraw reduction system can operate on various computing devices, such as a computer 210, mobile device 220 (e.g., a mobile phone, tablet computer, mobile media device, mobile gaming device, wearable computer, etc.), and other devices capable of receiving user inputs (e.g., such as a set-top box or vehicle-based computer). Each of these devices can include various input mechanisms (e.g., microphones, keypads, cameras, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 that, e.g., coordinates display element (e.g., view hierarchy) data structure information across user devices and/or performs computations regarding views. System 240 can be maintained in a cloud-based environment or other distributed server-client system. As described herein, user input (e.g., trace input via a virtual keyboard) can be communicated between devices 210 and 220 and/or to the system 240. In addition, information about the user or the user's device(s) 210 and 220 (e.g., the current and/or past location of the device(s), views displayed on each device, device characteristics, and user preferences and interests) can be communicated to the system 240. In some implementations, some or all of the system 240 is implemented in user computing devices such as devices 210 and 220.

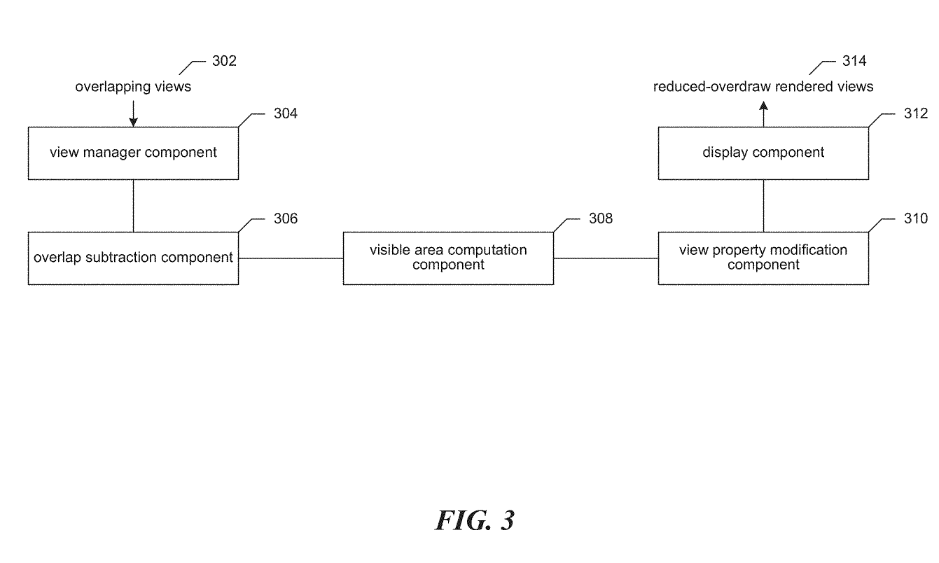

FIG. 3 is a data flow diagram illustrating logical relationships among automatic overdraw reduction components in accordance with an embodiment. In various embodiments, a computing system such as the computer system 100 of FIG. 1 and/or one or more other processing devices operably connectable to the computer system, such as a remote computing server, can implement the automatic overdraw reduction components and the data flows depicted in FIG. 3. In the illustrated embodiment, overlapping views 302 are provided to a view manager component 304. In various embodiments, the overlapping views 302 can include a directive to render a page of views, a command to add a view or modify the properties of a view, etc. For example, the overlapping views can include a series of list items to be displayed over a background view. The view manager component 304 can receive views, or a hierarchy of views, or commands regarding how to render or modify views, from a native application, an operating system user interface framework, a web browser, etc. In some embodiments, the view manager component 304 is a software component in a computing system display library or framework, e.g., a React system UIManagerModule class.

In the illustrated embodiment, the view manager component 304 is connected to an overlap subtraction component 306. The overlap subtraction component 306 can identify portions of a view (e.g., a background view) that intersect and are overlapped by another view (e.g., a foreground view). If the overlapping foreground view is opaque and thus occludes the overlapped background view, the overlap subtraction component 306 can subtract the dimensions of the overlapping or occluding portion from the background view. For example, the overlap subtraction component 306 can record in an overlap subtraction data structure, such as in a record associated with the background view, coordinates representing portions of the background view that are occluded on the display. In some embodiments, the overlap subtraction component 306 and/or a visible area computation component 308 can maintain a lightweight virtual representation of the occluded background view paralleling the unmodified view. The visible area computation component 308 is configured to determine whether, after subtraction of overlapping regions, the background view would cause anything to be displayed on the screen. In some embodiments, the visible area computation component 308 makes a binary determination of whether the overlapped element or view is completely occluded. In some embodiments, the visible area computation component 308 determines the remaining visible area, dimensions, and/or shape of the overlapped element or view. In some embodiments, the visible area computation component 308 is configured to determine whether the visible remainder portion of the view is a simple rectangle, as opposed to a more complex or irregular shape, to simplify resizing or other modification of the view by a view property modification component 310. In some embodiments, the visible area computation component 308 determines the smallest bounding rectangle in which a partly overlapped view can be fit, enabling the partially overdrawn view to be reduced in size to such a smaller rectangle.

Using the view information from the visible area computation component 308, a view property modification component 310 modifies the overdrawn view. In some embodiments, the view property modification component 310 sets a flag designating a view that is completely occluded as not to be drawn. In some embodiments, the view property modification component 310 omits such a completely occluded view from a hierarchy of views to be rendered. In some embodiments, the view property modification component 310 un-sets or otherwise removes a background property (e.g., an image or color) so that the view no longer directs a rendering engine to render that property. In some embodiments, the view property modification component 310 modifies a size property of the view (e.g., reducing the size of a partly occluded view to the minimum size needed to display the remaining visible portion of the view). By modifying properties of the view to avoid drawing overlapped regions that will not ultimately be displayed, memory resources that would be allocated to the view are saved, and the depth of the display hierarchy can be reduced in comparison to the original hierarchy of overlapping views. A display component 312 renders the modified views (e.g., via a native application programming interface (API) for rendering views, or a web browser XML DOM rendering engine) and displays the reduced-overdraw rendered views 314 after the modification of views to reduce overdraw by the view property modification component 310.

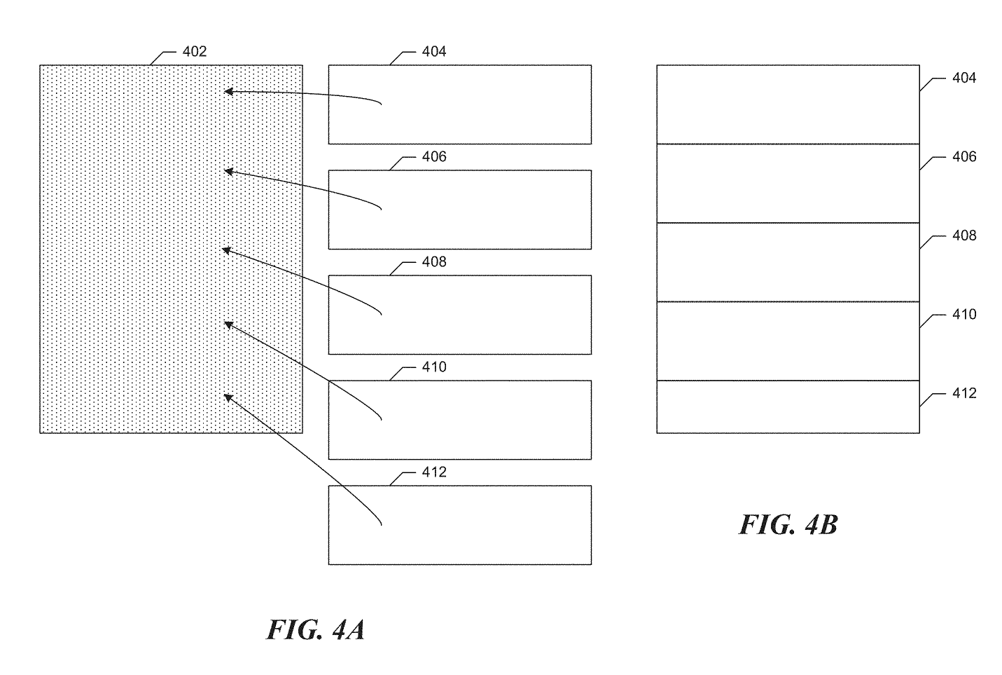

FIGS. 4A and 4B are display diagrams illustrating automatic overdraw reduction in accordance with an embodiment. It is common for a programmer or designer to express view layout in complete terms, for example, to describe a background view element as well as each overlying element, even if the overlying elements end up completely covering the background element. If the background view is not actually rendering anything, it is not needed for rendering purposes. The addressability of the background view is convenient for the original author, but not needed for the renderer and irrelevant to the ultimate viewer. To reduce the amount of rendering for views that are not fully visible, overdrawn views and/or portions of views can be reduced before the views are rendered.

In the example illustrated in FIGS. 4A and 4B, view hierarchy commands specify a series of rectangles to be rendered. FIG. 4A illustrates a full hierarchy specified by a programmer. A background view 402 draws a background image. A series of list element views 404-412 are to be displayed over the background view 402.

FIG. 4B illustrates the remaining views after the reduction of overdraw from the views illustrated in FIG. 4A. In particular, the background view 402 of FIG. 4A is not rendered in the views illustrated in FIG. 4B. Because the background view 402 is fully overdrawn or completely covered by the series of list element views 404-412, the background view 402 of FIG. 4A has no visible area to be displayed. Thus, the background view 402 has been modified to cause the background image not to be drawn. The modification of the background view 402 (e.g., unsetting its background image as described above with reference to the view property modification component 310 of FIG. 3) has no perceptible visual effect from a viewer's perspective, while the system avoids spending time and computing resources to compute and render the overdrawn background image.

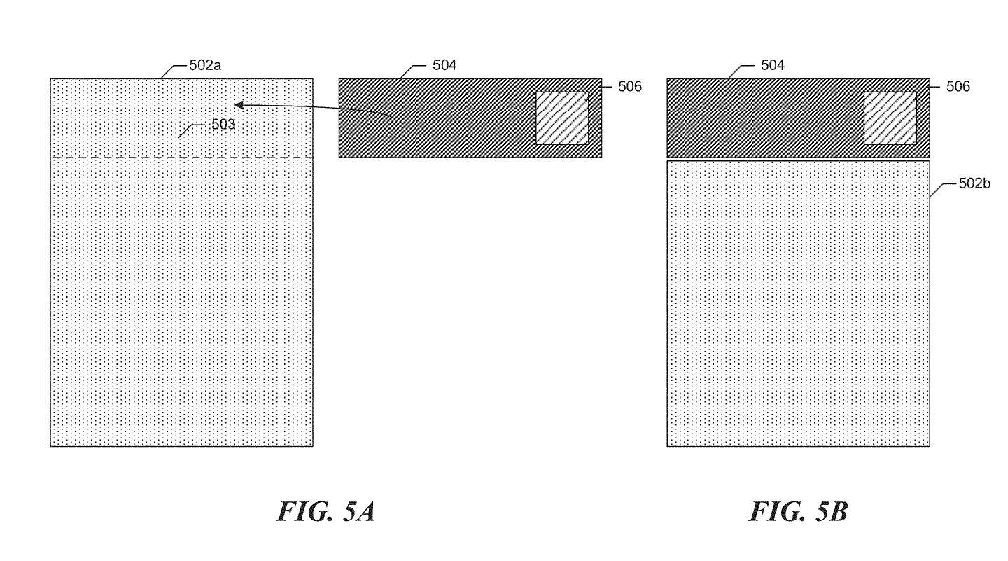

FIGS. 5A and 5B are display diagrams illustrating automatic overdraw reduction in accordance with an embodiment. In the example illustrated in FIGS. 5A and 5B, view hierarchy commands specify a different series of rectangles to be rendered. FIG. 5A illustrates a full set of views specified by a page author. A background view 502a draws a background color. A rectangular view 504 to be displayed over the background view 502a spans the width of the background view 502a and only part of the height of the background view 502a. A square view 506 is a child element of the rectangular view 504.

FIG. 5B illustrates the modification of the background view 502a from FIG. 5A to the reduced background view 502b after the reduction of overdraw from the views illustrated in FIG. 5A. An upper portion 503 of the background view 502a of FIG. 5A (designated by the area above the dashed line) is to be overdrawn by the rectangular view 504 and the square view 506; whether or not that overdrawn upper portion 503 is rendered, it will not be seen by an end user. As a result, in the views illustrated in FIG. 5B the size of the background view 502a is reduced to the remaining non-overdrawn portion of the background view 502a that is visible and displayed to the user once rendered. Thus, the background view 502b has been modified in size to exclude the overdrawn upper portion 503, causing the background color to be drawn only for the portion of the screen below the rectangular view 504. (For illustrative purposes, a gap is shown between the rectangular view 504 and the background view 502b to indicate the dimensions of the modified background view 502b; an automatic overdraw reduction system would display the elements to an end user seamlessly with no gap so that the reduction of overdrawn regions is not perceptible to a viewer.) The modification of the background view 502b saves rendering time and resources by reducing the rendering load, eliminating the need to send the overdrawn portion of the background color to a rendering engine.

In some cases, removing all overdrawn regions regardless of size, location, and/or dimension—including, e.g., scattered variously shaped elements—might end up creating more regions and causing more polygons to be rendered. In some embodiments, an automatic overdraw reduction system detects whether a background view is only partially occluded, and determines whether subtracting the overlying element would simplify the rendering of the overdrawn element. If not, the system can keep the overdrawn view without removing or modifying its properties in a manner that would increase the amount and/or complexity of the rendering load. In the illustrated example, the square view 506 does not affect the portion of the rectangular view 504 that is rendered, because subtracting the square view 506 from the rectangular view 504 does not reduce the rectangular view 504 to a smaller rectangular region.

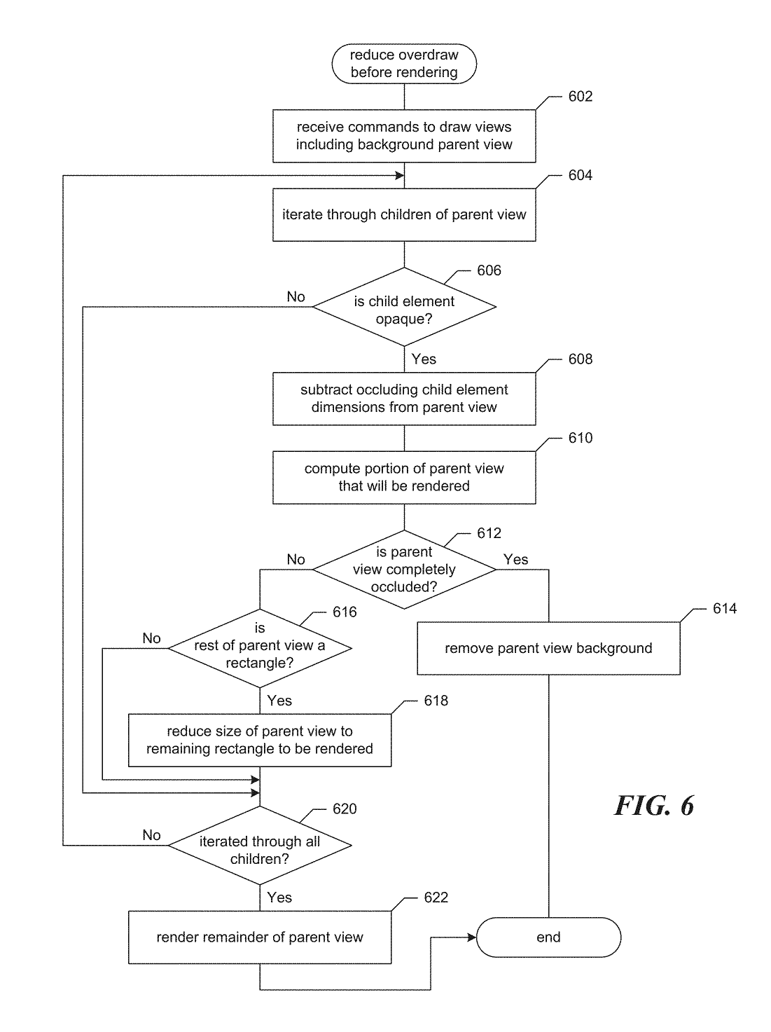

FIG. 6 is a flow diagram illustrating a process for a computer system (e.g., the computing system 100 of FIG. 1) to automatically reduce overdraw in accordance with an embodiment. In block 602, the computer system (e.g., the view manager component 304 of FIG. 3) receives a command or series of commands to draw a set of overlapping views including a background parent view that has one or more child views. In various embodiments, the computer system receives a command to render a hierarchy of elements or views for display. While such a hierarchy of views may be easy for a programmer or page designer to reason about, it can be inefficient to send occluded elements to a rendering component or system when those occluded elements will not end up being displayed on the screen. Accordingly, the process illustrated in FIG. 6 is responsible for reducing the amount of overdraw by eliminating and/or resizing background regions that are occluded by foreground elements, thus reducing the number and/or size of views to be rendered while respecting the final user interface.

In block 604, the computer system iterates through each child element of the background parent view to determine whether the parent view is partly or completely overdrawn by its children. In various embodiments, iterating through each child element includes fully traversing a tree or other data structure of the parent view's children (checking its children's children, and so on), e.g., via breadth-first search, depth-first search, recursion, etc. For example, a child of the parent view might be a container element that does not have a background color or image, but that contains its own children that do have backgrounds set. In some embodiments, iterating through child elements includes detecting overlapping views or elements that are not direct children, such as sibling elements within a common parent view (e.g., overlapping windows on a tablet screen).

In decision block 606, the computer system determines, for a particular child element selected in block 604, whether the child element is opaque. If the child element is not opaque (e.g., transparent as a result of not having a background image or color set, or translucent with partial opacity), then the child element does not occlude the portion of the parent view behind the child element, so the process continues iterating through child elements in block 620. If, however, the child element is opaque, then the process continues in block 608.

In block 608, the computer system determines the dimensions of the overlapping opaque portion of the child view that occludes the parent view, and subtracts those dimensions from the parent view (or, e.g., from a representation of the parent view to be substituted for the full parent view for rendering purposes). In block 610, the computer system computes the remaining portion of the parent view to be rendered after subtraction of the child view. For example, the subtraction of one or more child views may result in an empty parent view, in which no portion of the parent view will be rendered.

In decision block 612, if the parent view is completely occluded, such that no portion of the parent view remains to be rendered, the computer system determines that the parent view can be excluded from rendering, and the process continues in block 614. In block 614, the computer system removes the parent view background. In some embodiments, the system (e.g., the view property modification component 310 of FIG. 3) un-sets a background property of the parent view, so that the parent view does not require a background color or image to be rendered. In some embodiments, the system changes a property of the parent view so that it does not display anything, or removes the parent view from the set of views to be rendered. After block 614, the overdrawn element has been removed and the process ends.

Returning to decision block 612, if the parent view is not completely occluded, then the process continues in decision block 616. In decision block 616, the computer system determines whether the rest of the parent view is a simple rectangle. For example, if the child element covers a corner of the parent element, leaving a Utah-shaped region of the parent element visible, or a box within the parent element, leaving a doughnut-shaped region of the parent element visible (e.g., element 504 of FIG. 5 after subtracting element 506) then the computer system can determine that the remaining portion of the parent view is not a simple rectangle, and the process continues in decision block 620. On the other hand, if the child element covers, for example, the full width of the parent element and part but not all of the height of the parent element, then the computer system can determine that the remaining portion of the parent view is a simple rectangle (e.g., element 502b of FIG. 5 after subtracting element 504 from element 502a), and the process continues in block 618.

In block 618, the computer system reduces the size of the parent view to the size of the non-occluded rectangle remaining to be rendered. For example, as illustrated in FIG. 5, element 502a is reduced to the size of element 502b so that the rendering system does not have to render the portion of element 502a that would be occluded by element 504. In some embodiments, the system (e.g., the view property modification component 310 of FIG. 3) changes a size property or drawing coordinates of the parent view, so that the parent view is only rendered within the remaining visible area. In some embodiments, the system replaces the parent view with a substitute view that is not an exact copy of the original view, even though the same visual information is displayed. In various embodiments, if the parent view would render non-uniform content (e.g., a gradient, a picture, text, etc.), the computer system determines the appropriate portion of the content to render (e.g., the bottom half of a background image). After block 618, the process continues in decision block 620.

In decision block 620, if the system has not iterated through all children of the parent view, then the process continues in block 604. Once all children have been iterated through, then overdrawn regions of the parent view have been removed if possible, reducing the computing system's rendering load, and the process continues in block 622. In block 622, the computer system renders the remainder of the parent view, which may be, e.g., the entire parent view or a smaller rectangular region. After block 622, the process ends.

While processes or blocks are presented in a given order herein, alternative implementations can perform process blocks in a different order, and some components or blocks can be deleted, moved, added, subdivided, combined, and/or modified to provide alternative or sub combinations. Each of these components or blocks can be implemented in a variety of different ways. Also, while components or blocks are at times shown in series, these components or blocks can instead be performed or implemented in parallel, or can be performed at different times.

Embodiments operating in some or all of the ways described above provide a page rendering infrastructure that reduces the rendering of overdrawn view regions, reducing memory and processor utilization requirements and improving page or frame display speed.

### Conclusion

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited except as by the appended claims.

1. A method performed by a computing system having memory and a processor for reducing overdraw in a plurality of views including a background view before rendering the background view for display, comprising:
receiving a command to render the background view;
identifying a foreground view in the plurality of views;
determining that at least part of the foreground view overlaps at least a portion of the background view;
subtracting from the background view the portion of the background view overlapped by the foreground view, including reducing a size of the background view to remove the overlapping portion thereof when a remaining portion of the background view is a rectangle;
determining the remaining displayable section of the background view after the subtracting; and
modifying a property of the background view in response to the determining.

2. The method of claim 1 wherein the plurality of views comprises
information about native elements in a mobile device display environment.

3. The method of claim 1 wherein the plurality of views comprises
information about elements in an HTML or XML document object model.

4. The method of claim 1 wherein identifying a foreground view in
the plurality of views comprises iterating through each child view in a set of child views.

5. The method of claim 1 wherein determining that at least part of the foreground view overlaps at least a portion of the background view comprises determining that the foreground view is opaque.

6. The method of claim 1 wherein determining the remaining displayable section of the background view after the subtracting comprises determining that after the subtracting no section of the background view remains displayable, and wherein modifying a property of the background view in response to the determining comprises removing a color or image property such that the color or image will not be rendered.

7. The method of claim 1 wherein determining the remaining displayable section of the background view after the subtracting comprises determining that after the subtracting a subsection of the background view remains displayable, and wherein modifying a property of the background view in response to the determining comprises setting a coordinate or dimension of the background view such that only the subsection will be rendered.

8. A non-transitory computer-readable storage medium storing computer-executable instructions for causing a computing system having a processor to reduce overdraw in a plurality of views including a background view before rendering the plurality of views for display, the instructions comprising:
instructions for receiving a command to render the background view;
instructions for identifying a foreground view in the plurality of views;
instructions for determining that at least part of the foreground view overlaps at least a portion of the background view;
instructions for subtracting from the background view the portion of the background view overlapped by the foreground view;
instructions for determining the remaining displayable section of the background view after the subtracting; and
instructions for modifying, by the processor, a property of the background view in response to the determining.

9. The non-transitory computer-readable storage medium of claim 8 wherein the plurality of views comprises information about native elements in a mobile device display environment.

10. The non-transitory computer-readable storage medium of claim 8 wherein the plurality of views comprises information about elements in an HTML or XML document object model.

11. The non-transitory computer-readable storage medium of claim 8 wherein identifying a foreground view in the plurality of views comprises iterating through each child view in a set of child views.

12. The non-transitory computer-readable storage medium of claim 8 wherein determining that at least part of the foreground view overlaps at least a portion of the background view comprises determining that the foreground view is opaque.

13. The non-transitory computer-readable storage medium of claim 8 wherein determining the remaining displayable section of the background view after the subtracting comprises determining that after the subtracting no section of the background view remains displayable, and wherein modifying a property of the background view in response to the determining comprises removing a color or image property such that the color or image will not be rendered.

14. The non-transitory computer-readable storage medium of claim 8 wherein determining the remaining displayable section of the background view after the subtracting comprises determining that after the subtracting a subsection of the background view remains displayable, and wherein modifying a property of the background view in response to the determining comprises setting a coordinate or dimension of the background view such that only the subsection will be rendered.

15. A system in an electronic device for reducing overdraw in a plurality of views before rendering the views for display on a screen of the electronic device, comprising:
a set of one or more processors configured to:
receive a command to cause a background view and a foreground view in the plurality of views to be rendered;
identify that a foreground view in the plurality of views overdraws at least a portion of the background view and to subtract from the background view the portion of the background view overdrawn by the foreground view;
determine the remaining displayable section of the background view after the subtraction of each portion of the background view overdrawn by a foreground view;
a property of the background view based on the remaining displayable section of the background view as determined by the visible area computation component; and
a memory, coupled to the processor, configured to store the background view as modified in the plurality of views.

16. The system of claim 15 wherein the set of one or more processors is configured to receive a command to render native elements in a mobile device display environment.

17. The system of claim 15 wherein the set of one or more processors is further configured to iterate through each foreground view in the plurality of views that is a child of the background view.

18. The system of claim 15 wherein the set of one or more processors is further configured to determine that the foreground view that overdraws at least a portion of the background view is opaque.

19. The system of claim 15 wherein the set of one or more processors is configured to remove a color or image property of the background view based on a determination by the visible area computation component that no section of the background view remains displayable after the subtracting.

20. The system of claim 15 wherein the set of one or more processors is configured to set a coordinate or dimension of the background view such that only a subsection of the background view will be rendered based on a determination by the visible area computation component that only a subsection of the background view remains displayable after the subtracting.
